(19) United States
(12) Patent Application Publication
(10) Pub. No.: US 2011/0256258 A1
(43) Pub. Date: Oct. 20, 2011

(54) LENS MOLDING DIE AND INJECTION MOLDING DEVICE HAVING SAME

(75) Inventor: YUAN-LUNG KUO, Tu-Cheng (TW)

(73) Assignee: HON HAI PRECISION INDUSTRY CO., LTD., Tu-Cheng (TW)

(21) Appl. No.: 12/840,303

(22) Filed: Jul. 21, 2010

(30) Foreign Application Priority Data
Apr. 19, 2010 (TW) 99112206

(51) Int. Cl. B29C 45/42; B29C 45/00

(52) U.S. Cl. 425/556; 425/542

(57) ABSTRACT

An injection molding device includes a lens molding die. The lens molding die includes a male mold, cores inserted in the male mold, a support plate attached to the male mold, and fixing poles. The support plate defines a plurality of I-shaped first guiding holes spatially corresponding to the cores. The fixing poles correspond to the respective first guiding holes. Each fixing pole includes a body portion and a connecting portion extending from the body portion. The body portion has an I-shaped cross-section conforming to the first guiding hole. The body portion extends through the corresponding first guiding holes. The connecting portion is secured to the corresponding core.

### BACKGROUND

1. Technical Field

The present disclosure relates to molding technology and, particularly, to a lens molding die and an injection molding device having the lens molding die.

2. Description of Related Art

Generally, an injection molding device is required to injection-mold lenses in an injection molding process. The injection molding device includes a stationary plate, a female mold fixed to the stationary plate, a male mold facing towards the female mold, a support plate clamped with the male mold, a moveable plate supporting the support plate and the male mold, a plurality of cores inserted in the male mold, a fixing pole, and an ejector pin. The fixing pole passes through the support plate to affix the core into the male mold. The ejector pin passes through the support plate and the male mold.

During the injection molding process, the female mold is matched with the male mold to form a plurality of cavities; plastic is injected into the female mold and flows into the cavities. After the plastic has completely solidified, the male mold is removed from the female mold, and the ejector pin ejects the solidified plastic to drop off the male mold. However, the fixing pole is easily shaken because of the pushing force in the ejection step. Therefore, the cores may be shifted and the quality of the lenses molded by the next injection molding process will be influenced.

Therefore, it is desirable to provide a lens molding die and an injection molding device having the lens molding die, which can overcome or at least alleviate the above-mentioned problems.

### BRIEF DESCRIPTION OF THE DRAWINGS

FIG. 1 is a sectional view of an injection molding device including a lens molding die, according to a first exemplary embodiment.

FIG. 2 is a schematic, isometric view of the lens molding die of FIG. 1.

FIG. 3 is an exploded view of the lens molding die of FIG. 2.

FIG. 4 is similar to FIG. 3, but viewed from another aspect.

FIG. 5 is a sectional view of a fixing pole of the lens molding die of FIG. 2.

FIG. 6 is a sectional view of a fixing pole of a lens molding die, according to a second exemplary embodiment.

### DETAILED DESCRIPTION

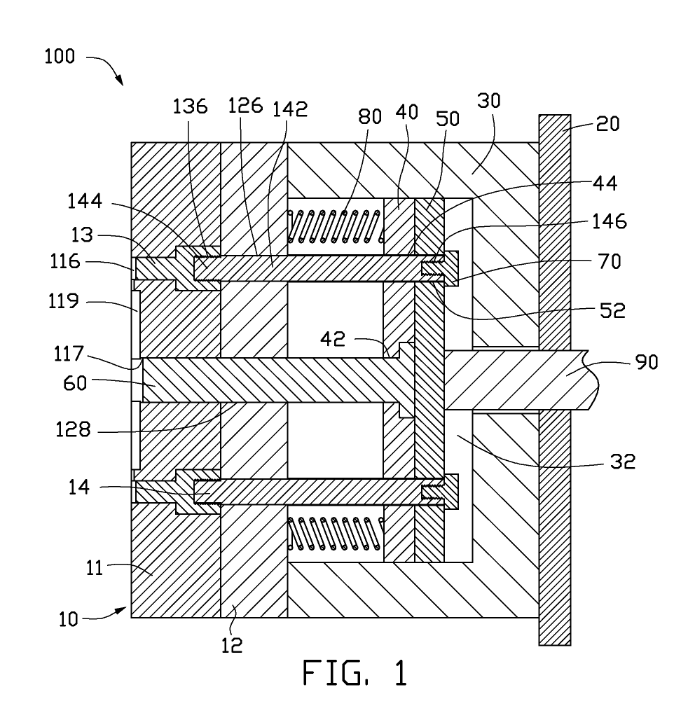

Referring to FIG. 1, an injection molding device 100, according to a first exemplary embodiment, includes a lens molding die 10, a movable plate 20, an ejector housing 30, a first ejector plate 40, a second ejector plate 50, an ejector pin 60, two screws 70, two resilient spring members 80, and an ejector pole 90.

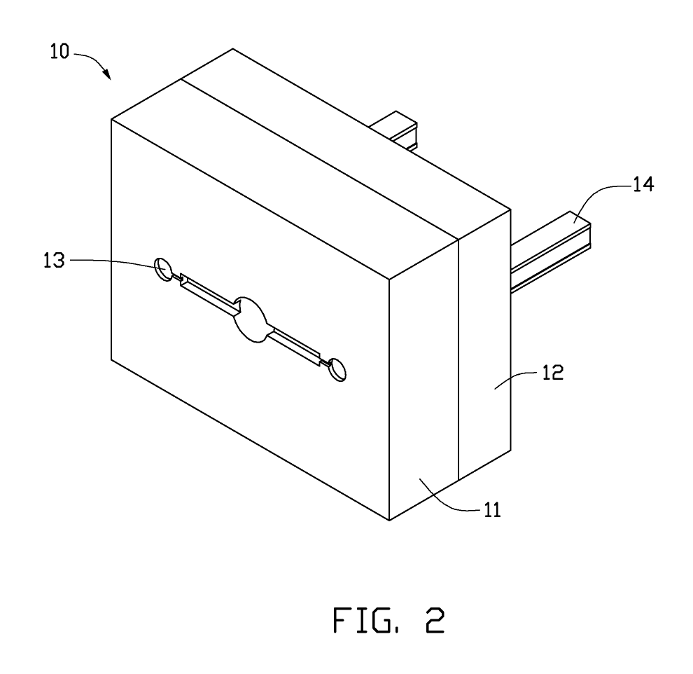

Referring to FIG. 2, the lens molding die 10 includes a male mold 11, a female mold (not shown) facing the male mold 11, a support plate 12, two cores 13, and two fixing poles 14 corresponding to the two cores 13.

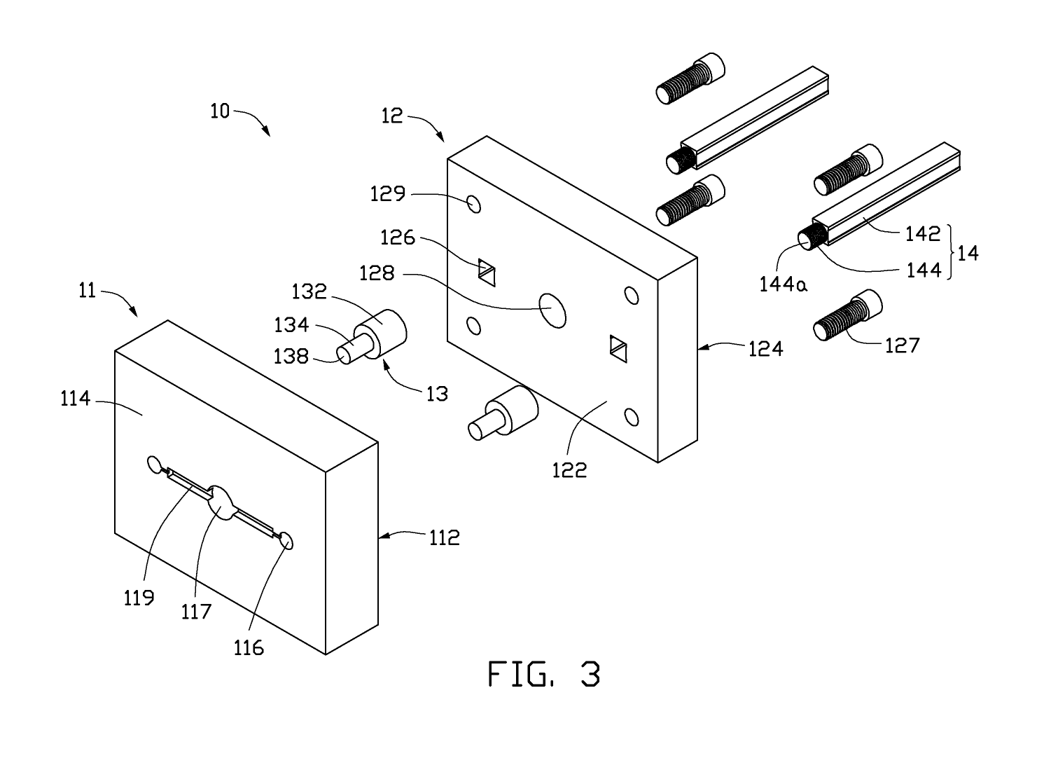

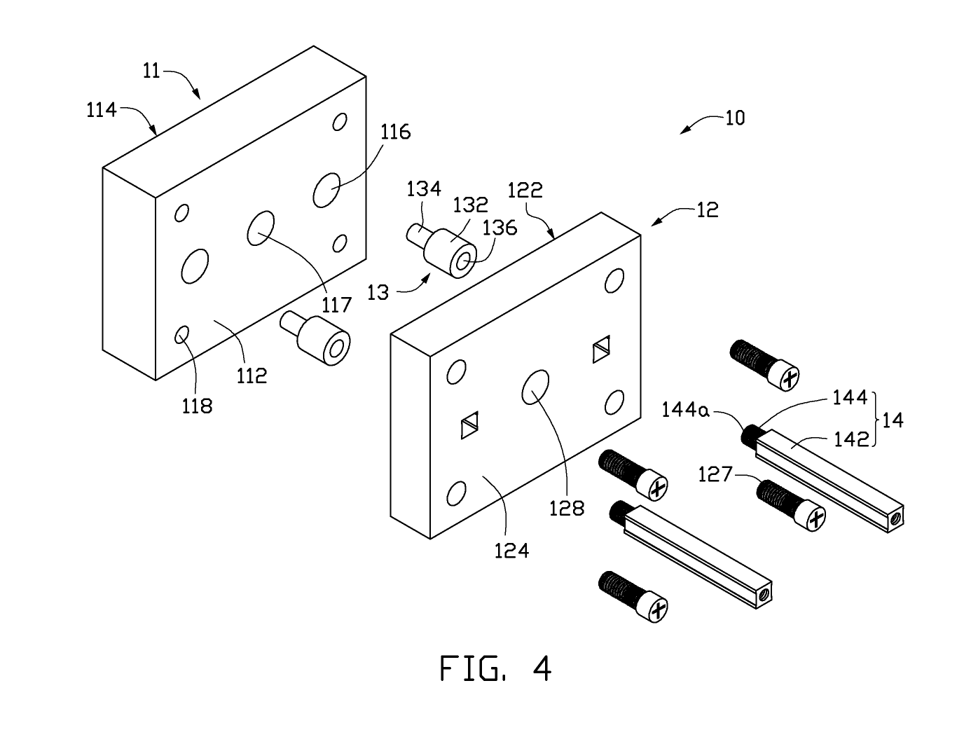

Referring to FIGS. 3-4, the male mold 11 includes a bottom surface 112 and a parting surface 114. The bottom surface 112 and the parting surface 114 are positioned at opposite sides of the male mold 11. The male mold 11 defines two core through holes 116 spaced from each other. The two core through holes 116 correspond to the two cores 13. A cold slug well 117 is defined in the male mold 11 and runs through the bottom surface 112 and the parting surface 114. The cold slug well 117 is positioned in the middle of the two core through holes 116. Four first threaded holes 118 are defined on the bottom surface 112. The four first threaded holes 118 are positioned at four corners of the male mold 11. Two runners 119 are defined on the parting surface 114. The two runners 119 are positioned at opposite sides of the cold slug well 117 and communicate with the cold slug well 117 and the two core through holes 116 respectively.

The support plate 12 includes a first surface 122 facing the bottom surface 112 and a second surface 124. The first surface 122 and the second surface 124 are at opposite sides of the support plate 12. Two I-shaped first guiding holes 126 and a first through hole 128 are defined in the support plate 12. The two first guiding holes 126 correspond to the two core through holes 116. The first through hole 128 corresponds to the cold slug well 117. Four first counter bores 129 are defined in the support plate 12 and run through the first surface 122 and the second surface 124. The four first counter bores 129 correspond to the four first threaded holes 118. Four bolts 127 pass through the four first counter bores 129 respectively and threadedly engage in the first threaded holes 118 so that the support plate 12 is attached to the male mold 11.

Each core 13 includes a bottom portion 132 and a top portion 134 opposite to the bottom portion 132. A second threaded hole 136 is defined in each bottom portion 132. A molding surface 138 is formed on the top of the top portion 134. The shape of the molding surface 138 matches with that of the lens (not shown).

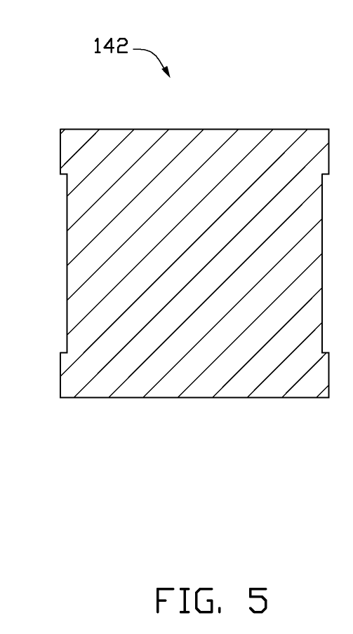

Each fixing pole 14 includes a body portion 142 and a connecting portion 144 extending from the body portion 142. The body portion 142 has an I-shaped cross-section along an axis of the fixing pole 14 (see FIG. 5). A third threaded hole 146 is defined in a distal end of the body portion 142 away from the connecting portion 144. The body portion 142 passes through the first guiding hole 126 and conforms to the first guiding hole 126. The connecting portion 144 is a cylinder. A thread 144a is formed on the connecting portion 144. The diameter of the connecting portion 144 is less than the width of the body portion 142. The connecting portion 144 passes through the first guiding hole 126 to threadedly engage in a corresponding second threaded hole 136 so that the connecting portion 144 is secured to the bottom portion 132. In other embodiments, the connecting portion 144 may be engaged in the bottom portion 132 directly.

The ejector housing 30 defines a receiving space 32 which is approximately C-shaped. The male mold 11 and the support plate 12 are secured to the ejector housing 30. The ejector housing 30 is fixed to the moveable plate 20 and is moved to a female mold (not shown) with the movement of the moveable plate 20.

The first ejector plate 40 defines a second counter bore 42 and two second guiding holes 44. The second counter bore 42 corresponds to the cold plug well 117, the first through hole 128, and the ejector pin 60. The two second guiding holes 44 correspond to the two first guiding holes 126.

The second ejector plate 50 defines two third guiding holes 52 corresponding to the two second guiding holes 44. The second ejector plate 50 is fixed to the first ejector plate 40. The first ejector plate 50 and the second ejector plate 60 are received in the receiving space 32.

The ejector pin 60 extends through the first through hole 128 and the cold plug well 117. The ejector pin 60 engages in the second counter bore 42 so that the ejector pin 60 is connected to the first ejector plate 40. Each body portion 142 extends through the third guiding hole 52, the second guiding hole 44, and the first guiding hole 126. Each screw 70 engages in the corresponding third threaded hole 146 and abuts against the second ejector plate 60.

Each resilient spring member 80 is a compression spring. The resilient spring members 80 interpose the supporting plate 12 and the first ejector plate 40. The ejector pole 90 extends through the moveable plate 20 and the ejector housing 30 to contact with the second ejector plate 50.

During an ejection step of an injection molding process, the ejector pole 90 pushes the second ejector plate 50 to move toward the support plate 12 along the fixing pole 14. The ejector pin 60 moves toward the support plate 12 with the movement of the second ejector plate 50 and pushes solidified plastic in the cold plug well 117. The solidified plastic is pushed to drop off from the male mold 11 and the resilient spring members 80 are compressed. The fixing pole 14 is difficult to be shaken as the limitation of the first guiding hole 126. Therefore, the cores 13 are positioned steadily in the core through holes 116 and the quality of the lenses molded by the next injection molding process will be ensured. When the ejector pole 90 moves away the second ejector plate 50, the resilient spring members 80 press the first ejector plate 40 and the second ejector plate 50 to move away the support plate 12 until the second ejector plate 50 is blocked by the screws 70. As a result, the movement time of the first ejector plate 40 and the second ejector plate 50 is saved, and the efficiency of the injection molding process increases.

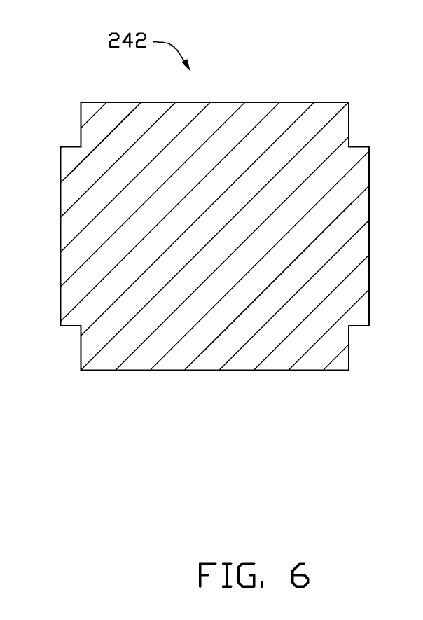

Referring to FIG. 6, a sectional view of a body portion 242 of a lens molding die (not shown), according to a second exemplary embodiment, is shown. The difference between the lens molding die of this embodiment and the lens molding die 10 of the first embodiment is that: the body portion 242 has a cross-shaped cross-section along an axis of the body portion 242.

The advantages of the body portion 242 of the second exemplary embodiment are similar to those of the body portion 142 of the first exemplary embodiment.

It is to be understood, however, that even though numerous characteristics and advantages of the present embodiments have been set fourth in the foregoing description, together with details of the structures and functions of the embodiments, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. An injection molding device, comprising:
a lens molding die, comprising:
a male mold;
a plurality of cores inserted in the male mold;
a support plate attached to the male mold and defining a plurality of I-shaped first guiding holes spatially corresponding to the cores;
a plurality of fixing poles corresponding to the respective first guiding holes, each fixing pole comprising a body portion and a connecting portion extending from the body portion, the body portion having an I-shaped cross-section conforming to the first guiding hole, the body portion extending through the corresponding first guiding hole, the connecting portion secured to the corresponding core.

2. The injection molding device as claimed in claim 1, wherein a plurality of first threaded holes are defined in the male mold, a plurality of first counter bores are defined in the support plate spatially corresponding to the first threaded holes, the male mold further comprises a plurality of bolts corresponding to the first counter bores, the bolts extend through the first counter bores and threadedly engages in the first threaded holes so that the support plate is securely attached to the male mold.

3. The injection molding device as claimed in claim 2, wherein the male mold comprises a bottom surface and a parting surface opposite to the bottom surface, a plurality of core through holes are defined in the male mold and spaced from each other, the cores are received in the core through holes and exposed at the bottom surface.

4. The injection molding device as claimed in claim 3, wherein a second threaded hole is defined in each core, a thread is formed on the connecting portion, the connecting portion threadedly engages in the second thread hole so that each fixing pole is secured to a corresponding core.

5. The injection molding device as claimed in claim 4, further comprising a moveable plate, an ejector housing defining a receiving space, a first ejector plate received in the receiving space, a second ejector plate fixed to the first ejector plate, an ejector pin, and an ejector pole, wherein the male mold and the support plate are secured to the ejector housing, the ejector housing is fixed to the moveable plate, a cold plug well is defined in the male mold, a first through hole corresponding to the cold plug well is defined in the support plate, a second counter bore corresponding to the first through hole and a plurality of second guiding holes are defined in the first ejector plate, the ejector pin extends through the first through hole and the cold plug well and engages in the second counter bore, a plurality of third guiding holes corresponding to the second guiding holes are defined in the second ejector plate, each body portion extends through a corresponding third guiding hole, a corresponding second guiding hole, and a corresponding first guiding hole, the ejector pole extends through the moveable plate and the ejector housing and abuts against the second ejector plate.

6. The injection molding device as claimed in claim 5, further comprising a plurality of resilient spring members, wherein the resilient spring members are interposed between the first ejector plate and the support plate.

7. The injection molding device as claimed in claim 6, further comprising a plurality of screws, a third threaded hole is defined in each body portion, each screw threadedly engages in a corresponding third threaded hole and abuts against the second ejector plate.

8. An injection molding device, comprising:
a lens molding die, comprising:
a male mold;
a plurality of cores inserted in the male mold;
a support plate attached to the male mold and defining a plurality of cross-shaped first guiding holes aligned with the corresponding cores;
a plurality of fixing poles spatially corresponding to the respective first guiding holes, each fixing pole comprising a body portion and a connecting portion extending from the body portion, the body portion having a cross-shaped cross-section conforming to the first guiding hole, the body portion extending through the corresponding first guiding hole, the connecting portion secured to the corresponding core.

9. The injection molding device as claimed in claim 8, wherein a plurality of first threaded holes are defined in the male mold, a plurality of first counter bores are defined in the support plate spatially corresponding to the first threaded holes, the male mold further comprises a plurality of bolts corresponding to the first counter bores, the bolts extend through the first counter bores and threadedly engages in the first threaded holes so that the support plate is securely attached to the male mold.

10. The injection molding device as claimed in claim 9, wherein the male mold comprises a bottom surface and a parting surface opposite to the bottom surface, a plurality of core through holes are defined in the male mold and spaced from each other, the cores are received in the core through holes and exposed at the bottom surface.

11. The injection molding device as claimed in claim 10, wherein a second threaded hole is defined in each core, a thread is formed on the connecting portion, the connecting portion threadedly engages in the second thread hole so that each fixing pole is secured to a corresponding core.

12. The injection molding device as claimed in claim 11, further comprising a moveable plate, an ejector housing defining a receiving space, a first ejector plate received in the receiving space, a second ejector plate fixed to the first ejector plate, an ejector pin, and an ejector pole, wherein the male mold and the support plate are secured to the ejector housing, the ejector housing is fixed to the moveable plate, a cold plug well is defined in the male mold, a first through hole corresponding to the cold plug well is defined in the support plate, a second counter bore corresponding to the first through hole and a plurality of second guiding holes are defined in the first ejector plate, the ejector pin extends through the first through hole and the cold plug well and engages in the second counter bore, a plurality of third guiding holes corresponding to the second guiding holes are defined in the second ejector plate, each body portion extends through a corresponding third guiding hole, a corresponding second guiding hole, and a corresponding first guiding hole, the ejector pole extends through the moveable plate and the ejector housing and abuts the second ejector plate.

13. The injection molding device as claimed in claim 12, further comprising a plurality of resilient spring members, wherein the resilient spring members are interposed between the first ejector plate and the support plate.

14. The injection molding device as claimed in claim 13, further comprising a plurality of screws, a third threaded hole is defined in each body portion, each screw threadedly engages in a corresponding third threaded hole and abuts the second ejector plate.

15. A lens molding die, comprising:
a male mold;
a plurality of cores inserted in the male mold;
a support plate attached to the male mold and defining a plurality of first guiding holes corresponding to the cores;
a plurality of fixing poles each fixing pole comprising a body portion and a connecting portion extending from the body portion, the body portion non-rotatably extending through the corresponding first guiding hole, the connecting portion secured to the corresponding core, the body portion movable in the corresponding first guiding hole along a lengthwise direction thereof.
